(19) United States
(12) Patent Application Publication
(10) Pub. No.: US 2023/0220945 A1
(43) Pub. Date: Jul. 13, 2023

(54) COATED CAST IRON PIPE OR FITTING FOR USE IN AGGRESSIVE ENVIRONMENTS

(71) Applicant: Charlotte Pipe and Foundry Company, Charlotte, NC (US)

(72) Inventors: Matthew Chance CLODFELTER, Locust, NC (US); Cameron G. OSBORNE, Locust, NC (US); David G. WAGGONER, Denver, NC (US); Thomas J. COSTELLO, Charlotte, NC (US)

(21) Appl. No.: 17/575,339

(22) Filed: Jan. 13, 2022

(51) Int. Cl. F16L 58/08; F16L 58/18; B05D 7/14; C25D 13/20; C25D 13/14

(52) U.S. Cl. CPC F16L 58/08; F16L 58/18; B05D 7/146; C25D 13/20; C25D 13/14

(57) ABSTRACT

Coated cast iron pipe and a method of making the coated cast iron pipe having an inner and an outer diameter are provided. A pipe pretreatment is applied on the inner diameter and the outer diameter of the cast iron pipe. A cathodic electrocoat is applied on the pipe pretreatment on the inner diameter and the outer diameter, and an anodic electrocoat is applied on the cathodic electrocoat on the inner diameter and the outer diameter. A coated cast iron fitting wherein a cast iron fitting having an inner and outer diameter is provided. The cast iron fitting is treated with a rust inhibiting pretreatment. The pretreated fitting is electrocoated with a cathodic primer coat, the cathodic primer coat is hot cured in an oven, and the hot cured fitting is coated with an epoxy acrylic powder coat.

### FIELD OF THE INVENTION

The present invention relates to pipes and fittings used in aggressive environments, more particularly to a coated cast iron pipe or fitting for use in an aggressive environment.

### BACKGROUND OF THE INVENTION

There is a need in the plumbing industry for pipes and fittings suitable for use in aggressive drain-waste-vent (DWV) applications, specifically for applications that may need enhanced protection, like hospitals, commercial kitchens, casinos, among others.

Epoxy paint coated cast iron pipes and fittings are available in the marketplace. There are disadvantages associated with epoxy paint applied to cast iron pipes and fittings. Epoxy paint coated on pipe has extremely poor adhesion. In order to get epoxy paint to adhere to cast iron, one must score the pipe to create a 4 to 6 mil mechanical anchor pattern and then clean all of the residue created by scoring the pipe before applying the epoxy.

Another disadvantage of epoxy paint coated on cast iron is that epoxy paint has a high level volatile organic chemicals (VOCs) that likely would not meet US Environmental Protection Agency limits. Also, epoxy paint is susceptible to ultraviolet (UV) degradation and will begin to chalk when exposed to sunlight.

Thus, there is a need in the market for alternative solutions to solve the problems associated with use of traditional and epoxy paint coated cast iron pipes and fittings in aggressive drain-waste-vent (DWV) applications. The pipes and fittings of the present invention purport to overcome these problems.

### SUMMARY OF THE INVENTION

The present invention relates to coated cast iron pipes and fittings designed for aggressive drain-waste-vent (DWV) applications. In certain aggressive DWV environments, for example, the piping system may need enhanced protection. Aggressive applications include, for example, exposure to undiluted cleaners, hospitals, casinos, commercial kitchens, soda fountains, bar sinks, parking garages, among others.

In an aspect of the invention, a coated cast iron pipe is provided. The coated cast iron pipe is comprised of a cast iron pipe having an inner diameter and an outer diameter, a pipe pretreatment is applied on the inner diameter and the outer diameter of the cast iron pipe, a cathodic electrocoat (e-coat) on the pipe pretreatment on the inner diameter and the outer diameter, and an anodic electrocoat (e-coat) on the cathodic e-coat on the inner diameter and the outer diameter. The pipe pretreatment is selected from the group consisting of zinc phosphate, iron phosphate, zirconium, and a combination thereof.

In an aspect of the invention, a coated cast iron pipe is provided. The coated cast iron pipe is comprised of a cast iron pipe having an inner diameter and an outer diameter, zinc phosphate applied on the inner diameter and the outer diameter of the cast iron pipe, a cathodic e-coat on the zinc phosphate on the inner diameter and the outer diameter, and an anodic e-coat on the cathodic e-coat on the inner diameter and the outer diameter.

In another aspect of the invention, a coated fitting is provided. The coated fitting is comprised of a cast iron fitting having an inner diameter and an outer diameter, a fitting pretreatment applied on the inner diameter and the outer diameter of the cast iron fitting, a cathodic e-coat on the fitting pretreatment on the inner diameter and the outer diameter, and an epoxy acrylic powder coat on the cathodic e-coat on the inner diameter and the outer diameter. The fitting pretreatment is selected from the group consisting of zinc phosphate, iron phosphate, zirconium, and a combination thereof.

In another aspect of the invention, a coated fitting is provided. The coated fitting is comprised of a cast iron fitting having an inner diameter and an outer diameter, zinc phosphate applied on the inner diameter and the outer diameter of the cast iron fitting, a cathodic e-coat on the zinc phosphate on the inner diameter and the outer diameter, and an epoxy acrylic powder coat on the cathodic e-coat on the inner diameter and the outer diameter.

In another aspect of the invention, a method of making a coated pipe is provided. The method comprises providing a cast iron pipe having an inner diameter and an outer diameter, reaming the inner diameter of the cast iron pipe, shot blasting the outer diameter of the cast iron pipe, optionally reaming the inner diameter of the cast iron pipe a second time, coating with a rust inhibiting pre-treatment, electrocoating the pre-treated pipe with a cathodic primer coat, hot curing the cathodic primer coat in an oven, and coating the hot cured pipe with an anodic top coat.

In another aspect of the invention, a method of making a coated fitting is provided. The method comprises mold fitting a pattern in a green sand mold, filling mold with molten iron, removing fitting having an inner diameter (ID) and an outer diameter (OD) from the green sand mold, shot blasting ID and OD, removing excess material from fitting, coating the cast iron fitting with rust inhibiting pretreatment, electrocoating the pretreated fitting with a cathodic primer coat, hot curing the cathodic primer coat in an oven, and coating the hot cured fitting with an epoxy acrylic powder coat. Hot curing can also occur after coating the hot cured fitting with an epoxy acrylic powder coat.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 illustrates a coated cast iron pipe in accordance with an embodiment of the present invention.

FIG. 2 illustrates a coated cast iron fitting in accordance with an embodiment of the present invention.

FIG. 3 is a process flow diagram illustrating a method of making a coated pipe in accordance with an embodiment of the present invention.

FIG. 4 is a process flow diagram illustrating a method of making a coated fitting in accordance with an embodiment of the present invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

As used herein, any usage of the terms “pipe” and the “end” of a pipe are intended to be understood and interpreted, in their broadest generic sense not inconsistent with but not limited to any common industry usage. A “pipe” is used herein to encompass any tubular structure capable of fluid conveyance therethrough and an “end” of a pipe is any termination of the tubular structure defining an opening through which fluid enters or exits the pipe. A “pipe” may be linear (straight) or non-linear (e.g., curvilinear) in the direction of fluid conveyance, and may be of differing transverse cross-sectional shapes, often round but not necessarily cylindrical or uniform in transverse cross-section. Pipes include for example tubular structures with uniform inner and outer diameters defining a cylindrical tubular structure, as are often commonly referred to as pipes, but also include other tubular components.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

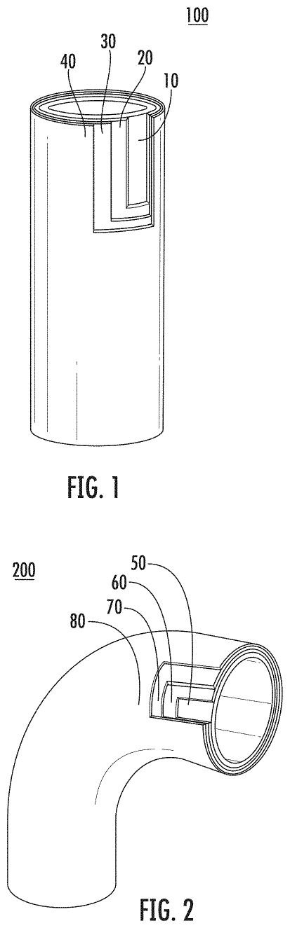

Referring to the figures, FIG. 1 illustrates a coated cast iron pipe 100 in accordance with an embodiment of the present invention. Coated pipe 100 comprises a cast iron pipe 10 having an inner diameter and an outer diameter, a pipe pretreatment 20 applied on the inner diameter and the outer diameter of the cast iron pipe, a cathodic e-coat 30 on the pipe pretreatment on the inner diameter and the outer diameter, and an anodic e-coat 40 on the cathodic e-coat on the inner diameter and the outer diameter. The pipe pretreatment may be selected from the group consisting of zinc phosphate, iron phosphate, zirconium, and a combination thereof. It is desirable for the pipe pretreatment to be rust inhibiting.

Pipe pretreatment 20 has a target thickness in a range of 100 mg/ft² to 300 mg/ft², preferably 150 mg/ft² to 200 mg/ft². The cathodic base coat 30 has a target thickness in a range of 0.9 mil to 2.5 mil. The anodic topcoat has a target thickness in a range of 2 mil to 6 mil.

The pipe and fittings of the present invention will not chalk when exposed to sunlight. Therefore, it is not necessary to store the pipe and fittings of the present invention inside or under cover.

Coated cast iron pipe 100 may vary in diameter and length. For example, the pipe may be 2 inch to 15 inch in diameterx10 foot in length to meet the needs of most all aggressive DWV applications. The coated cast iron pipe conforms to industry standards as traditional cast iron (CISPI 301 and ASTM A 888 for Hubless; ASTM A 74 for Service and Extra Heavy). The coated cast iron pipe of the present invention meets or exceeds all of the coating performance requirements in EN 877.

FIG. 2 illustrates a coated cast iron fitting 200 in accordance with an embodiment of the present invention. Coated cast iron fitting 200 may vary in diameter. For example, the fitting may be 2 inch to 15 inch in diameter. The coated fitting 200 is comprised of a cast iron fitting 50 having an inner diameter and an outer diameter, a fitting pretreatment 60 applied on the inner diameter and the outer diameter of the cast iron fitting, a cathodic e-coat 70 on the fitting pretreatment on the inner diameter and the outer diameter, and an epoxy acrylic powder coat 80 on the cathodic e-coat on the inner diameter and the outer diameter. Epoxy acrylic powder coat 80 has a target thickness in a range of 2 mil to 10 mil, preferably, 5 mil to 7 mil. Epoxy acrylic powder coat 80 is ultraviolet (UV) resistant. Fitting pretreatment 60 has a target thickness in a range of 100 mg/ft² to 300 mg/ft², preferably 150 mg/ft² to 200 mg/ft². Fitting pretreatment 60 may be selected from the group consisting of zinc phosphate, iron phosphate, zirconium, and a combination thereof. It is desirable for the fitting pretreatment to be rust inhibiting.

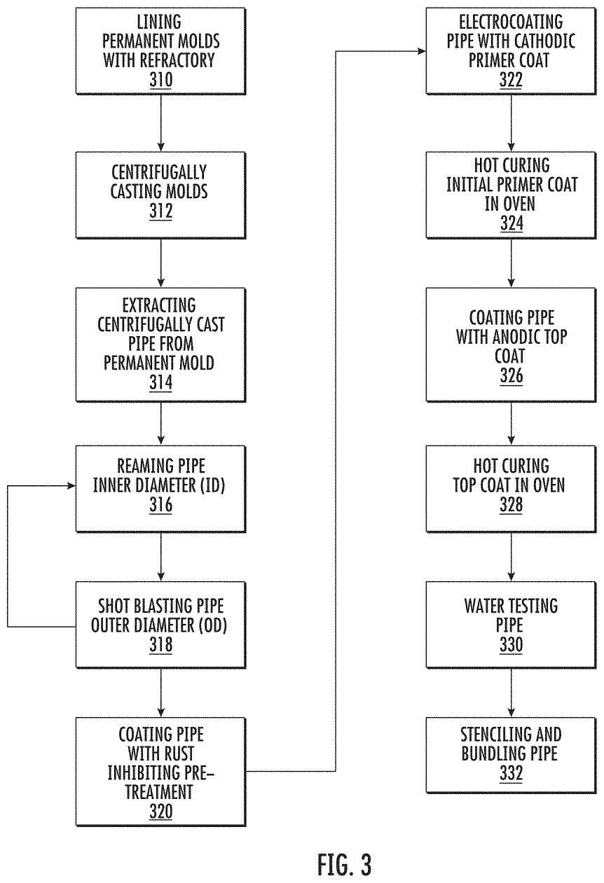

FIG. 3 is a process flow diagram illustrating a method of making a coated pipe in accordance with an embodiment of the present invention. Referring to FIG. 3, the method comprises lining permanent molds with refractory which is shown in block 310, centrifugally casting molds which is shown in block 312, and extracting centrifugally cast pipe from permanent mold which is shown in block 314. The method further comprises reaming pipe inner diameter (ID) which is shown in block 316 and shot blasting pipe outer diameter (OD) which is shown in block 318. Just prior to coating, the inner diameter may be reamed a second time. Reaming and shot blasting prepare the pipe surface for coating. Improving the inner diameter improves flow. Shot blasting the outer diameter (OD) removes the slurry, which is needed for the conductive electrocoating base-coat and decreases the surface profile. The initial reaming is done at the pipe machine and the second reaming is done just prior to coating. Coating pipe with rust inhibiting pre-treatment is shown in block 320.

Electrocoating (also referred to herein as e-coating) is a method of painting that uses electrical current to deposit paint. The fundamental principle that makes electrocoating work is that opposites attract which is known as electrodeposition. This is made possible by a DC rectifier to create voltage between a conductive part and counter-charged electrodes that are immersed in an electrocoat paint tank.

There are two types of electrocoating processes: anodic and cathodic. With anodic e-coating, the part to be coated is the anode with a positive electrical charge that attracts negatively charged paint particles in the paint bath. This process offers excellent color and gloss control. With cathodic e-coating, the part to be coated is the cathode with a negative electrical charge that attracts positively charged paint particles in the paint bath. By reversing polarities used in the anodic process, the amount of soluble iron in the paint film is greatly reduced, thereby increasing corrosion resistance.

E-coating provides essentially complete coverage of the outer diameter and inner diameter of the pipe or fitting, the coating has a uniform thickness and superior edge coverage with minimal or no drips or runs.

Electrocoating pipe with cathodic primer coat is shown in block 322, hot curing the initial primer coat in oven is shown in block 324, coating pipe with an anodic top coat is shown in block 326, hot curing the top coat in an oven is shown in block 328, water testing pipe is shown in block 330, and stenciling and bundling pipe is shown in block 332. “Hot curing” generally refers to heating the primer/paint and substrate to a temperature in a range of 350° F. to 400° F. This is what allows the paint to cross link and harden.

With regard to surface preparation and coatings of the pipe, a slurry is utilized. The slurry is comprised of a refractory material, a binder, water, and a surfactant. The inner diameter is reamed at the pipe machine. As indicated in FIG. 3, just prior to coating, the inner diameter may be reamed a second time, and the outer diameter is shot blasted. These steps prepare the surface of the pipe for coating. Reaming the inner diameter also improves flow.

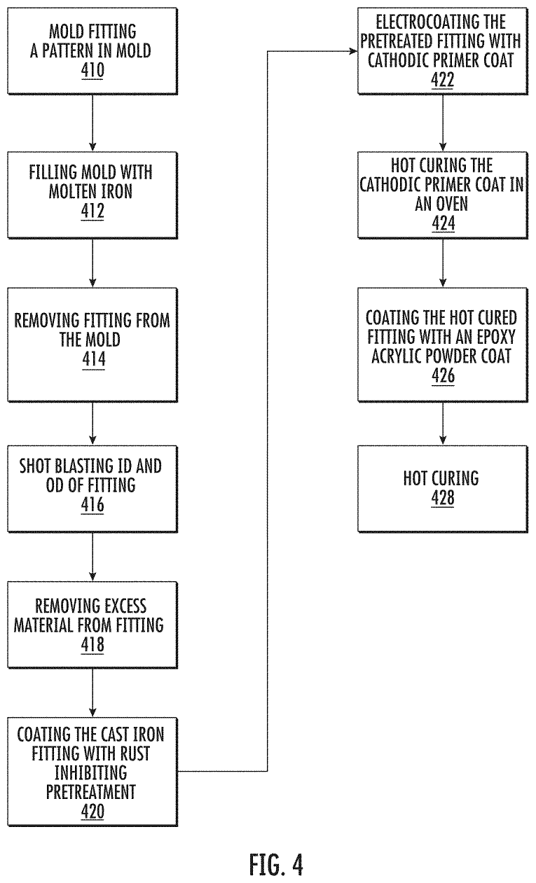

In another aspect of the invention, a method of making a coated fitting is provided. Referring to FIG. 4, the method comprises mold fitting a pattern in a green sand mold 410, filling mold with molten iron 412, removing fitting having an inner diameter (ID) and an outer diameter (OD) from the green sand mold 414, shot blasting ID and OD 416, removing excess material from fitting 418, coating the cast iron fitting with rust inhibiting pretreatment 420, electrocoating the pretreated fitting with a cathodic primer coat 422, hot curing the cathodic primer coat in an oven 424, and coating the hot cured fitting with an epoxy acrylic powder coat 426. Hot curing 428 can also occur after coating the hot cured fitting with an epoxy acrylic powder coat.

Pipe and fittings of the present invention pass the following performance specifications per EN 877: 350 hours of salt spray testing; resistance to wastewater for 30 days at 73° F.; chemical resistance from pH 2 to pH 12 for 30 days at 73° F.; resistance to hot water for 24 hours at 203° F. Among the main advantages of the pipe and fittings of the present invention are superior salt spray and pH test performance, not susceptible to delamination, will not chalk with UV exposure, fittings have pretreatment and e-coat for protection if topcoat chips.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A coated pipe comprising:
a cast iron pipe having an inner diameter and an outer diameter;
a pipe pretreatment applied on the inner diameter and the outer diameter of the cast iron pipe, wherein the pipe pretreatment is selected from the group consisting of zinc phosphate, iron phosphate, zirconium, and a combination thereof;
a cathodic electrocoat on the pipe pretreatment on the inner diameter and the outer diameter; and
an anodic electrocoat on the cathodic electrocoat on the inner diameter and the outer diameter.

2. The coated pipe according to claim 1, wherein the pipe pretreatment is applied on the inner diameter in a thickness in a range of 100 mg/ft² to 300 mg/ft².

3. The coated pipe according to claim 2, wherein the pipe pretreatment is applied on the inner diameter in a thickness in a range of 150 mg/ft² to 200 mg/ft².

4. The coated pipe according to claim 1, wherein the pipe pretreatment is applied on the outer diameter in a thickness in a range of 100 mg/ft² to 300 mg/ft².

5. The coated pipe according to claim 4, wherein the pipe pretreatment is applied on the outer diameter in a thickness in a range of 150 mg/ft² to 200 mg/ft².

6. The coated pipe according to claim 1, wherein the pipe pretreatment is zinc phosphate.

7. The coated pipe according to claim 1, wherein the cathodic electrocoat has a thickness in a range of 0.9 mil to 2.5 mil.

8. The coated pipe according to claim 1, wherein the anodic electrocoat has a thickness in a range of 2 mil to 6 mil.

9. A coated fitting comprising:
a cast iron fitting having an inner diameter and an outer diameter;
a fitting pretreatment applied on the inner diameter and the outer diameter of the cast iron fitting, wherein the fitting pretreatment is selected from the group consisting of zinc phosphate, iron phosphate, zirconium, and a combination thereof;
a cathodic electrocoat on the fitting pretreatment on the inner diameter and the outer diameter; and
an epoxy acrylic powder coat on the cathodic electrocoat on the inner diameter and the outer diameter.

10. The coated fitting according to claim 9, wherein the fitting pretreatment is applied on the inner diameter in a thickness in a range of 100 mg/ft² to 300 mg/ft².

11. The coated fitting according to claim 10, wherein the fitting pretreatment is applied on the inner diameter in a thickness in a range of 150 mg/ft² to 200 mg/ft².

12. The coated fitting according to claim 9, wherein the fitting pretreatment is applied on the outer diameter in a thickness in a range of 100 mg/ft² to 300 mg/ft².

13. The coated fitting according to claim 12, wherein the fitting pretreatment is applied on the outer diameter in a thickness in a range of 150 mg/ft² to 200 mg/ft².

14. The coated fitting according to claim 9, wherein the fitting pretreatment is zinc phosphate.

15. The coated fitting according to claim 9, wherein the cathodic electrocoat has a thickness in a range of 0.9 mil to 2.5 mil.

16. The coated fitting according to claim 9, wherein the epoxy acrylic powder coat has a thickness in a range of 2 mil to 6 mil.

17. A method comprising:
providing a cast iron pipe having an inner diameter and an outer diameter,
coating the cast iron pipe with a pipe pretreatment,
electrocoating the pretreated pipe with a cathodic primer coat,
hot curing the cathodic primer coat in an oven, and
coating the hot cured pipe with an anodic top coat.

18. The method according to claim 17, wherein the pipe pretreatment is selected from the group consisting of zinc phosphate, iron phosphate, zirconium, and a combination thereof.

19. The method according to claim 17, wherein the pipe pretreatment is zinc phosphate.

20. The method according to claim 17, wherein the pipe pretreatment is rust inhibiting.

21. The method according to claim 17, wherein the pipe pretreatment is applied on the inner diameter in a thickness in a range of 100 mg/ft² to 300 mg/ft².

22. The method according to claim 21, wherein the pipe pretreatment is applied on the inner diameter in a thickness in a range of 150 mg/ft² to 200 mg/ft².

23. The method according to claim 17, wherein the pipe pretreatment is applied on the outer diameter in a thickness in a range of 100 mg/ft² to 300 mg/ft².

24. The method according to claim 23, wherein the pipe pretreatment is applied on the outer diameter in a thickness in a range of 150 mg/ft² to 200 mg/ft².

25. A method comprising:
providing a cast iron fitting,
coating the cast iron fitting with rust inhibiting pretreatment,
electrocoating the pretreated fitting with a cathodic primer coat,
hot curing the cathodic primer coat in an oven, and
coating the hot cured fitting with an epoxy acrylic powder coat.

26. The method according to claim 25, further comprising hot curing after coating the hot cured fitting with an epoxy acrylic powder coat.

27. The method according to claim 25, wherein the fitting pretreatment is selected from the group consisting of zinc phosphate, iron phosphate, zirconium, and a combination thereof.

28. The method according to claim 27, wherein the fitting pretreatment is zinc phosphate.

29. The method according to claim 25, wherein the fitting pretreatment is rust inhibiting.

30. The method according to claim 25, wherein the fitting pretreatment is applied on the inner diameter in a thickness in a range of 100 mg/ft² to 300 mg/ft².

31. The method according to claim 30, wherein the fitting pretreatment is applied on the inner diameter in a thickness in a range of 150 mg/ft² to 200 mg/ft².

32. The method according to claim 25, wherein the fitting pretreatment is applied on the outer diameter in a thickness in a range of 100 mg/ft² to 300 mg/ft².

33. The method according to claim 32, wherein the fitting pretreatment is applied on the outer diameter in a thickness in a range of 150 mg/ft² to 200 mg/ft².

34. The method according to claim 25, wherein the epoxy acrylic powder coat has a thickness in a range of 2 mil to 6 mil.
